(19) United States
(12) Patent Application Publication
(10) Pub. No.: US 2019/0066201 A1
(43) Pub. Date: Feb. 28, 2019

(54) SYSTEM AND METHOD FOR DYNAMICALLY RECEIVING MORTGAGE INFORMATION VIA TEXT MESSAGING

(71) Applicant: LOANBOT LLC, Henderson, NV (US)

(72) Inventors: Jeffrey BERTHIAUME, JR., Buda, TX (US); Elliot BLOCH, Henderson, NV (US)

(73) Assignee: LOANBOT LLC, Henderson, NV (US)

(21) Appl. No.: 15/690,942

(22) Filed: Aug. 30, 2017

(51) Int. Cl. G06Q 40/00; G06K 7/14; H04W 4/14; H04L 29/08

(52) U.S. Cl. CPC G06Q 40/00; G06K 7/1417; G06Q 50/16; H04L 67/02; H04W 4/14

(57) ABSTRACT

A system and method for obtaining mortgage information via text messaging are provided. The method includes scanning, via a camera of a mobile terminal, an image of a multi-dimensional barcode corresponding to a target real estate property, and extracting a Short Message Service (SMS) Uniform Resource Locator (URL), via a processor of the mobile terminal, from the multi-dimensional barcode. The method further includes generating and transmitting, via a cellular network, a text message to a phone number indicated in the SMS URL. The web server loads a custom code for property information of the target real estate property based on the transmission by the mobile terminal. The webserver transmitting, via a data network, a first inquiry based on the custom code. The mobile terminal transmits a response, and the web server transmits estimated mortgage payment information based on the transmitted response.

### BACKGROUND

### 1. Field of the Disclosure

The present disclosure relates to a system and method for dynamically providing a mortgage information service. More particularly, the present disclosure relates to dynamic providing of mortgage information via automated text messaging.

### 2. Background Information

Multi-dimensional barcodes have been gaining more popularity to store and provide additional information that was not previously available for traditional single dimension barcodes. For example, multi-dimensional barcodes may store a web address corresponding to a website. The multi-dimensional barcodes have been used to direct a user to a website, which may provide additional information for a particular product or provide a form for inputting additional information.

When shopping for homes, many consumers may search for potential homes based on their desired criteria, such as its location, neighborhood, square footage, number of bedrooms, and the like, before looking into to see whether such a home is within financial reach of the consumer. Due to a large number of variable factors of consideration, financial affordability may not typically be a foremost consideration. Accordingly, such consumers may spend unnecessary time looking at homes that may be out of financial reach or forgo certain homes assuming such homes are not financially viable, rendering the process less than efficient or desirable. Further, due to slow mobile internet connections, and various navigation operations that are required to be performed, it may be cumbersome and time consuming to perform such financial analysis in an outdoor environment for multiple homes.

Further, some consumers may prefer to drive by various neighborhoods of interest before looking at any specific homes. For example, consumers interested in homes belonging in a particular school district may prefer to only consider homes within that district. These consumers come across homes being advertised for purchase with written advertising materials or QR Codes® that may be scanned to be directed to a website corresponding to the property being advertised for sale.

### BRIEF DESCRIPTION OF THE DRAWINGS

FIG. 1 shows an exemplary general computer system that is configured to combine alphabet characters of differing languages, according to an aspect of the present disclosure;

FIG. 2 shows an exemplary process for generating a real estate property code, according to an aspect of the present disclosure;

FIG. 3 shows an exemplary flow process for obtaining mortgage information, according to an aspect of the present disclosure;

FIG. 4 shows an exemplary flow process for obtaining mortgage information, according to an aspect of the present disclosure;

FIG. 5 shows an exemplary flow process for obtaining a preferred communication method, according to an aspect of the present disclosure;

FIG. 6 shows an exemplary flow process for obtaining mortgage information off-line, according to an aspect of the present disclosure; and

FIG. 7 shows an exemplary data flow for obtaining mortgage information, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” and the like are not intended to limit the order of the processes, and these words are instead used to guide the reader through the description of the methods. Further, any reference to claim elements in the singular, for example, using the articles “a,” “an” or “the”, is not to be construed as limiting the element to the singular.

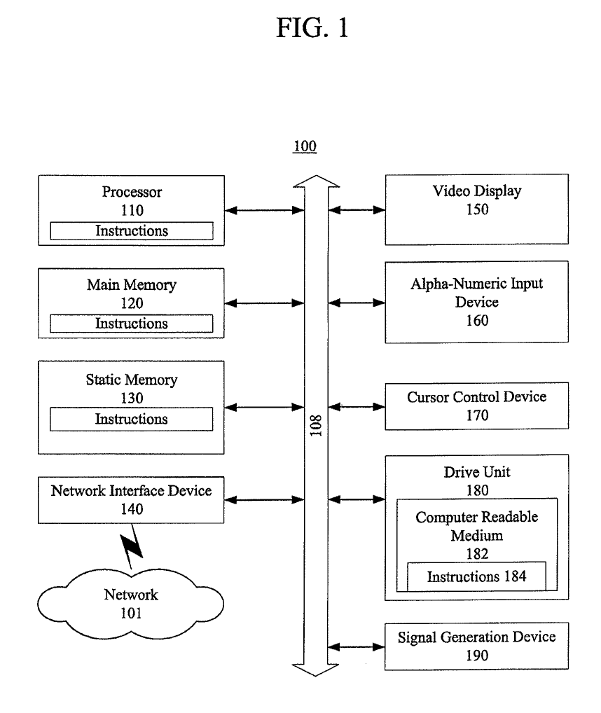

FIG. 1 shows an exemplary general computer system that is configured to combine alphabet characters of differing languages, according to an aspect of the present disclosure.

A computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as a stationary network computer or a server, a mobile computer, a mobile terminal, a personal computer (PC), a laptop computer, a tablet computer, a wireless smart phone, a set-top box (STB), a personal digital assistant (PDA), a wearable device, a communications device, a control system, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen or pad. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140.

The network interface device 140 may include one or more transmitters and one or more receivers. For example, the network interface device 140 may include a data transmitter and a data receiver, and a cellular signal transmitter and a cellular signal receiver. The network interface device 140 may be capable of receiving and transmitting Wi-Fi signals, wireless data network signals, cellular signals and the like. Further, the network interface device 140 may also include a Global Positioning System (GPS) signal receiver for receiving GPS signals.

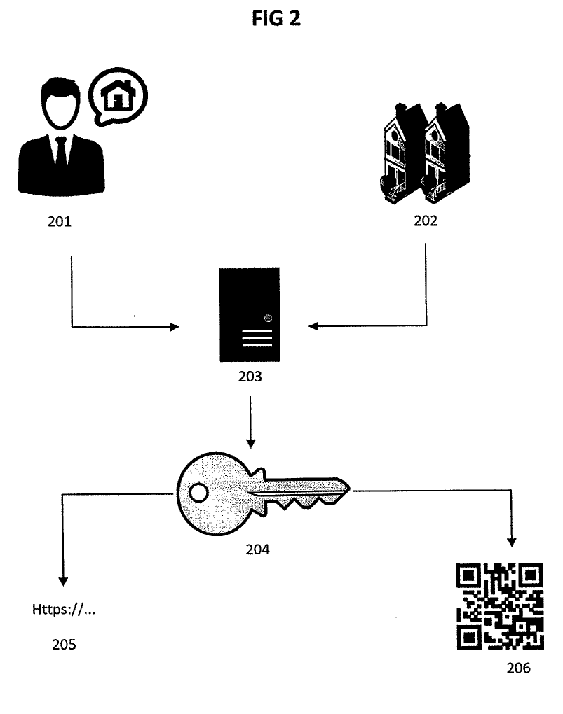

FIG. 2 shows an exemplary process for generating a real estate property code for obtaining mortgage information, according to aspects of the present application.

Realtor 201 may register contact information to a web server 203. For example, the realtor 201 may provide contact information of a realty company or an agent representing a corresponding real estate property. Further, the realtor 201 may register information of real estate property 202 to the web server 203. The information of the real estate property 202 may include, without limitation, property address, property type (e.g., single home, condo, commercial, and the like) price, annual tax, HOA fees due, school information, crime information and the like.

The web server 203 may generate a key 204 based on the registered information of the realtor 201 and the real estate property 202. For example, the key 204 may provide information for a specific combination of the realtor 201 provided information and the real estate property 202. Based on the key 204, a custom URL 205 or a multi-dimensional barcode 206 may be generated.

In an example, the custom URL 205 may be a short message service (SMS) uniform resource locator (URL) or other types of text URLs. The custom URL 205 may include a path or a virtual phone number corresponding to a web server including information corresponding to the real estate property 202. Further, the custom URL 205 may also include an identifier or the key 204 corresponding to the real estate property 202, which may be used to retrieve information corresponding to the real estate property 202.

The multi-dimensional barcode 206 may store a custom URL storing a link or an identifier corresponding to various information of the real estate property 202, such as property address, price, annual tax, HOA fees due, school information, crime information, contact information of real estate agent or company representing the real estate property 202, and the like.

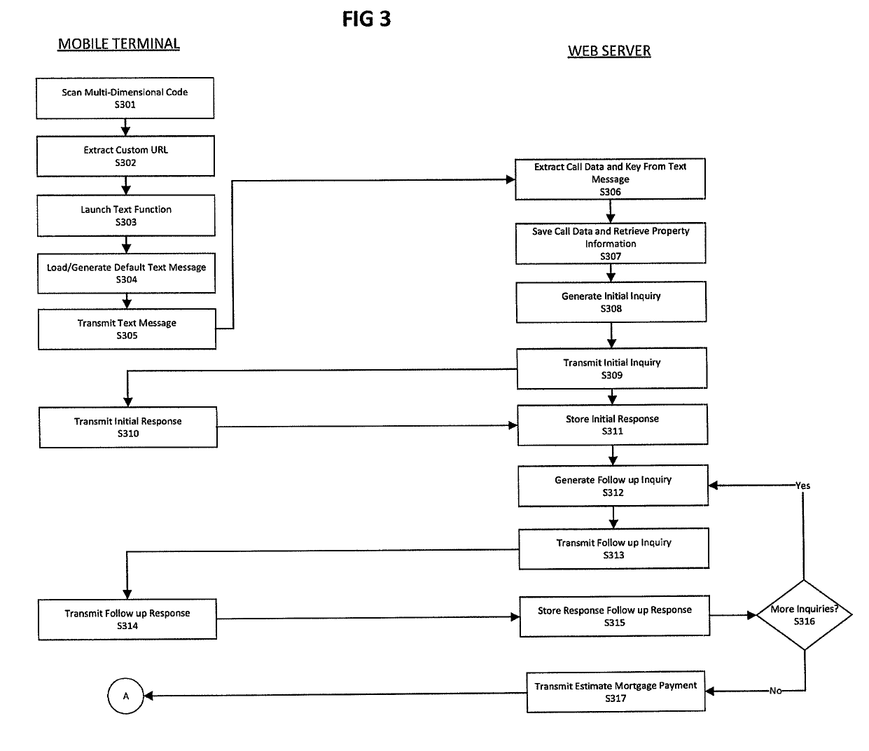

FIG. 3 shows an exemplary flow process for obtaining mortgage information, according to aspects of the present application.

In operation 301, an image of a multi-dimensional barcode provided for a target real estate property (or real estate property of interest) is captured or scanned with a camera on a mobile terminal. The mobile terminal may include a display, a processor, a memory, a cellular signal receiver, a cellular signal transmitter, a data receiver, a data transmitter, a Global Positioning System (GPS) receiver and the like. The mobile terminal may be a smart phone, a personal computing device, a wearable computing device or the like.

In an example, the multi-dimensional barcode may be a QR Code®, QYOO® code, or the like. The multi-dimensional barcode may be printed in a black-and-white pattern, grayscale, or any combination of colors. The multi-dimensional barcode may be provided on a “for-sale” sign at a real estate property or on a publication (e.g., printed or digital) of the real estate property.

The multi-dimensional barcode may store a custom URL corresponding to the target real estate property and/or information of the real estate property. For example, the custom URL may include an identifier or a key corresponding to the target real estate property and a virtual phone number corresponding to a web server including information of the real estate property. However, aspects of the present disclosure are not limited thereto, such that the custom URL may also directly include information of the real estate property.

In operation 302, in response to scanning of the multi-dimensional barcode, a custom URL is extracted or read from the multi-dimensional barcode. In an example, the custom URL may be a SMS URL, which may trigger a text function to be launched in operation 303.

In operation 303, a text messaging function is launched on the mobile device in response to the scanning of the custom URL. In an example, the text messaging function is generally provided on most or all mobile communication devices and may be used to transmit text and/or other information through a cellular network. Text messages that may be transmitted through the cellular network may include Short Message Service (SMS), Multimedia Messaging Service (MMS) and the like. In contrast to text messaging, instant messaging applications are generally proprietary and may require a specific application to be procured to utilize its services. Further, instant messaging may utilize wireless data network, rather than the cellular network, and requires a communicating party to utilize the same application to perform communication. Further, the instant messaging application may further require login and password information, whereas the text messaging function may simply utilize a phone number associated with the cellular service.

In operation 304, a default message corresponding to the custom URL is loaded or generated in a draft text message format. In an example, the default message may include a key or identifier corresponding to the target real estate property. Further, the default message may also specify a phone number to which the default message is to be transmitted.

In operation 305, the mobile terminal transmits, to a virtual phone number corresponding to a web server storing information related to real estate properties. The mobile terminal may transmit the default message automatically upon loading or generation. Alternatively, the mobile terminal may transmit the loaded default message in response to an input by a user of the mobile terminal. The text transmission may be transmitted through a cloud based application programming interface (API), such as Twilio®. The cloud based API will process the received text message and transmit a request to a network address of the web server corresponding to the virtual phone number. The request may include the identifier or key corresponding to the target real estate property. The request may be a data request or a web request.

In operation 306, the web server receives and parses the request transmitted in operation 305, extracts the identifier or key corresponding to the target real estate property, as well as the call data (e.g., phone number of the mobile terminal).

In operation 307, the web server saves the phone number of the mobile terminal in its database or memory and retrieves information corresponding to the target real estate property based on the extracted identifier or key. For example, the retrieved information may include one or more of property address, property type (e.g., single house, town home, condo, commercial real-estate, land, and the like), listed price, annual tax, HOA fees due, school information, crime information, and the like. Further, the property information may also include contact information of real estate agent or company representing the real estate property.

In operation 308, the web server generates a request for information of special status relevant to the mortgage application as an initial inquiry. For example, the request for information may inquire whether the user is part of military service or is a veteran. However, aspects of the present disclosure is not limited thereto, such that the question may inquire whether the user is part of government work force that may be provided with special status during a mortgage application process (e.g., teacher, government employee, and the like). In an example, the request for information may be generated in eXtensible Markup Language (XML) or other similar computer language.

In operation 309, the web server transmits the request to the cloud API, which parses and processes the received request, and relays the request in a SMS text format to the mobile terminal.

In operation 310, the mobile terminal receives the request message and provides a response in a free text format to the inquiry. For example, the user may simply indicate “no” or “N” to the text inquiry. Acceptable responses may be predefined or prestored for the inquiries or requests transmitted by the web server. The text message response may be transmitted via the cloud API similar to operation 305.

In operation 311, the web server registers and stores the response in its database or memory. The user provided response may be saved corresponding to the phone number of the phone number. In an example, the saved responses may be time stamped and may have a predetermined validity period (e.g., 3 months). The saved responses may be reused for other codes corresponding to other properties, such that no responses may be provided for subsequent scanning of codes for receiving mortgage information. Further, the web server may additionally ask other inquiries, such as expected down payment, maximum monthly payment expected by the user, estimated credit score range, loan type of interest, and the like. The number of inquiries and responses may be adjusted according to its usage.

In operation 312, the web server generates a follow up inquiry. The follow up inquiry may be based on the response provided by the user of the mobile terminal. In an example, the follow up inquiry may include one or more of user's expected down payment, estimated credit rating (e.g., excellent, good, fair, poor or a numerical value), first time ownership, primary residence expected, maximum monthly payment desired, desired loan terms, annual salary, and the like.

In operation 313, the web server transmits the follow up inquiry to the cloud API, which parses and processes the received request, and relays the request in a SMS text format to the mobile terminal similar to operation 309.

In operation 314, the mobile terminal receives the request message and provides a response in a free text format to the follow up inquiry. The text message response may be transmitted via the cloud API similar to operation 305.

In operation 315, the web server registers and stores the follow up response and proceeds to operation 315. In operation 316, the web server determines whether further follow up inquiries are to be generated based on the responses received. If the web server determines that additional follow up inquiries are to be generated, then operation S312 is executed. If the web server determines that no further follow up inquiries are to be generated, then the method proceeds to operation S317.

In operation S317, the web server transmits a response with estimated mortgage information. For example, the estimated mortgage information may include expected monthly payments. The estimated mortgage information may be provided with or without HOA fees, expected taxes, and insurance payments added in. In addition, the estimated mortgage information may provide the user with available loan qualification information based on responses provided. For example, the estimate mortgage information may provide expected monthly payments based on various credit score ranges, if credit score information was not provided by the user. Alternatively, if the user provided the maximum monthly payment information, the web server may provide potential loan products that may be available based on provided responses (e.g., veteran loan, 30 year fixed, specifying minimum down payment required, minimum FICO score required, minimum monthly income, and the like).

As exemplarily described above, the above noted process allows the mobile terminal to more quickly obtain mortgage information without navigating through a website to obtain a mortgage estimate. Further, the above noted process allows for more efficient delivery of mortgage information by transmitting minimal data for providing of mortgage information. Accordingly, in this regard, the mobile terminal may be relied upon to quickly obtain affordability information even when physically traveling to property sites with slower or less reliable data connections.

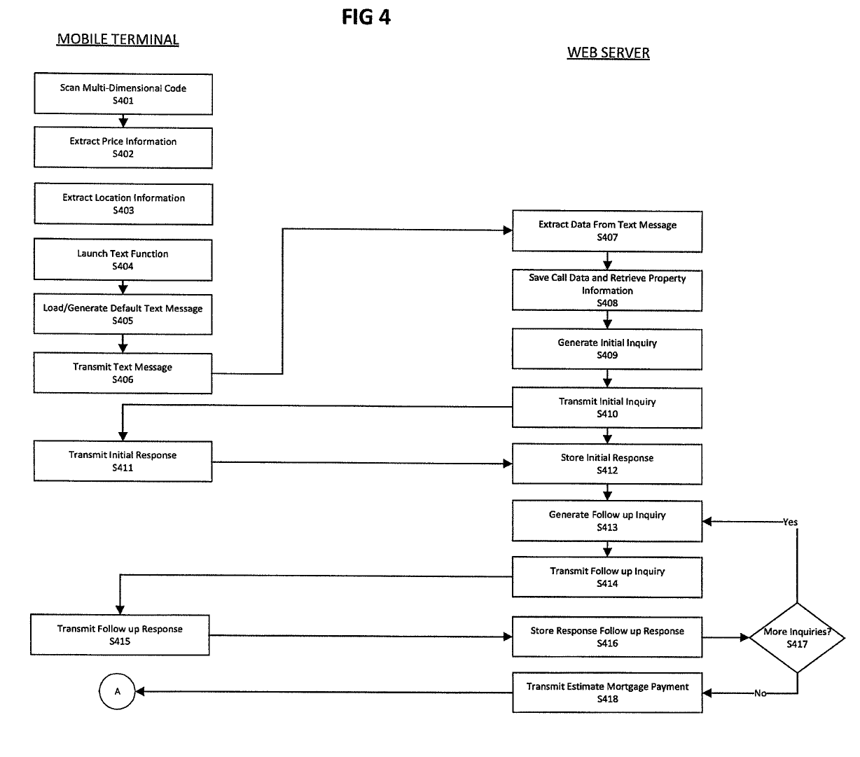

FIG. 4 shows an exemplary flow process for obtaining mortgage information, according to an aspect of the present disclosure.

In operation 401, an image of a multi-dimensional barcode provided for a target real estate property (or real estate property of interest) is captured or scanned with a camera on a mobile terminal. The mobile terminal may include a display, a processor, a memory, a cellular signal receiver, a cellular signal transmitter, a data receiver, a data transmitter, a Global Positioning System (GPS) receiver and the like. The mobile terminal may be a smart phone, a personal computing device, a wearable computing device or the like.

In an example, the multi-dimensional barcode may be a QR Code®, QYOO® code, or the like. The multi-dimensional barcode may be printed in a black-and-white pattern, grayscale, or any combination of colors. The multi-dimensional barcode may be provided on a “for-sale” sign at a real estate property or on a publication (e.g., printed or digital) of the real estate property.

The multi-dimensional barcode may store a custom URL corresponding to the target real estate property and/or information of the real estate property. For example, the custom URL may include an identifier or a key corresponding to the target real estate property and a virtual phone number corresponding to a web server including information of the real estate property. However, aspects of the present disclosure are not limited thereto, such that the custom URL may also directly include information of the real estate property.

In operation 402, in response to scanning of the multi-dimensional barcode, a custom URL is extracted or read from the multi-dimensional barcode. In an example, the custom URL may be a SMS URL. Further, the custom URL may further include at least price information of the target real estate property.

In operation 403, the mobile terminal extracts its location information. For example, the location information of the mobile terminal may be GPS location information, digital map information (e.g., HD map) or location information determined by triangulation of cellular signals.

In operation 404, a text messaging function is launched on the mobile device in response to the scanning of the custom URL. In an example, the text messaging function is generally provided on most or all mobile communication devices and may be used to transmit text and/or other information through a cellular network. Text messages that may be transmitted through the cellular network may include Short Message Service (SMS), Multimedia Messaging Service (MMS) and the like. In contrast to text messaging, instant messaging applications are generally proprietary and may require a specific application to be procured to utilize its services. Further, instant messaging may utilize wireless data network, rather than the cellular network, and requires a communicating party to utilize the same application to perform communication. Further, the instant messaging application may further require login and password information, whereas the text messaging function may simply utilize a phone number associated with the cellular service.

In operation 405, a default message corresponding to the custom URL is loaded or generated in a draft text message format. In an example, the default message may include a key or identifier corresponding to the target real estate property. Further, the default message may also specify a phone number to which the default message is to be transmitted.

In operation 406, the mobile terminal transmits, to a virtual phone number corresponding to a web server storing information related to real estate properties. The mobile terminal may transmit the default message automatically upon loading or generation. Alternatively, the mobile terminal may transmit the loaded default message in response to an input by a user of the mobile terminal. The text transmission may be transmitted through a cloud based application programming interface (API), such as Twilio®. The cloud based API will process the received text message and transmit a request to a network address of the web server corresponding to the virtual phone number. The request may include the identifier or key corresponding to the target real estate property. The request may be a data request or a web request.

In operation 407, the web server receives and extracts data included in the request transmitted in operation 406.

In operation 408, the web server saves the phone number of the mobile terminal in its database or memory and identifies a zip code based on the location information. In this regard, at least because the zip code is determined based on the location information determined by the mobile terminal, estimated mortgage may be determined more quickly than conventional system, which may require navigating through a large database for identification of target data.

However, aspects of the present disclosure are not limited thereto, such that a listing of the target real estate property may be identified based on the location information. Upon identification of the property, relevant information may be retrieved. The retrieved information may include one or more of property address, property type (e.g., single house, town home, condo, commercial real-estate, land, and the like), listed price, annual tax, HOA fees due, school information, crime information, and the like. Further, the property information may also include contact information of real estate agent or company representing the real estate property.

In operation 409, the web server generates a request for information of special status relevant to the mortgage application as an initial inquiry. For example, the request for information may inquire whether the user is part of military service or is a veteran. However, aspects of the present disclosure is not limited thereto, such that the question may inquire whether the user is part of government work force that may be provided with special status during a mortgage application process (e.g., teacher, government employee, and the like). In an example, the request for information may be generated in eXtensible Markup Language (XML) or other similar computer language.

In operation 410, the web server transmits the request to the cloud API, which parses and processes the received request, and relays the request in a SMS text format to the mobile terminal.

In operation 411, the mobile terminal receives the request message and provides a response in a free text format to the inquiry. For example, the user may simply indicate “no” or “N” to the text inquiry. Acceptable responses may be predefined or pre-stored for the inquiries or requests transmitted by the web server. The text message response may be transmitted via the cloud API similar to operation 406.

In operation 412, the web server registers and stores the response in its database or memory. The user provided response may be saved corresponding to the phone number of the phone number. In an example, the saved responses may be time stamped and may have a predetermined validity period (e.g., 3 months). The saved responses may be reused for other codes corresponding to other properties, such that no inquiries may be generated for subsequent scanning of codes for receiving mortgage information. Further, the web server may additionally ask other inquiries, such as expected down payment, maximum monthly payment expected by the user, estimated credit score range, loan type of interest, and the like. The number of inquiries and responses may be adjusted according to its usage.

In operation 413, the web server generates a follow up inquiry. The follow up inquiry may be based on the response provided by the user of the mobile terminal. In an example, the follow up inquiry may ask regarding the user's expected down payment, estimated credit rating (e.g., excellent, good, fair, poor or a numerical value), first time ownership, primary residence expected, maximum monthly payment desired, desired loan terms, annual salary, and the like. Further, the follow up inquiry may also inquire about a type of the target real estate property (e.g., condo, townhome, a single home, investment home, commercial property, land and the like).

In operation 414, the web server transmits the follow up inquiry to the cloud API, which parses and processes the received request, and relays the request in a SMS text format to the mobile terminal similar to operation 410.

In operation S415, the mobile terminal receives the request message and provides a response in a free text format to the follow up inquiry. The text message response may be transmitted via the cloud API similar to operation S406.

In operation S416, the web server registers and stores the follow up response and proceeds to operation S417. In operation S417, the web server determines whether further follow up inquiries are to be generated based on the responses received. If the web server determines that additional follow up inquiries are to be generated, then operation S413 is executed. If the web server determines that no further follow up inquiries are to be generated, then the method proceeds to operation S418.

In operation S418, the web server transmits a response with estimated mortgage information. For example, the estimated mortgage information may include expected monthly payments. The estimated mortgage information may be provided with or without HOA fees, expected taxes, and insurance payments added in. In addition, the estimated mortgage information may provide the user with available loan qualification information based on responses provided. For example, the estimate mortgage information may provide expected monthly payments based on various credit score ranges, if credit score information was not provided by the user. Alternatively, if the user provided the maximum monthly payment information, the web server may provide potential loan products that may be available based on provided responses (e.g., veteran loan, 30 year fixed, specifying minimum down payment required, minimum FICO score required, minimum monthly income, and the like).

As exemplarily described above, the above noted process allows the mobile terminal to more quickly obtain mortgage information without navigating through a website to obtain a mortgage estimate. Further, the above noted process allows for more efficient delivery of mortgage information by transmitting minimal data for providing of mortgage information. Accordingly, in this regard, the mobile terminal may be relied upon to quickly obtain affordability information even when physically traveling to property sites with slower or less reliable data connections.

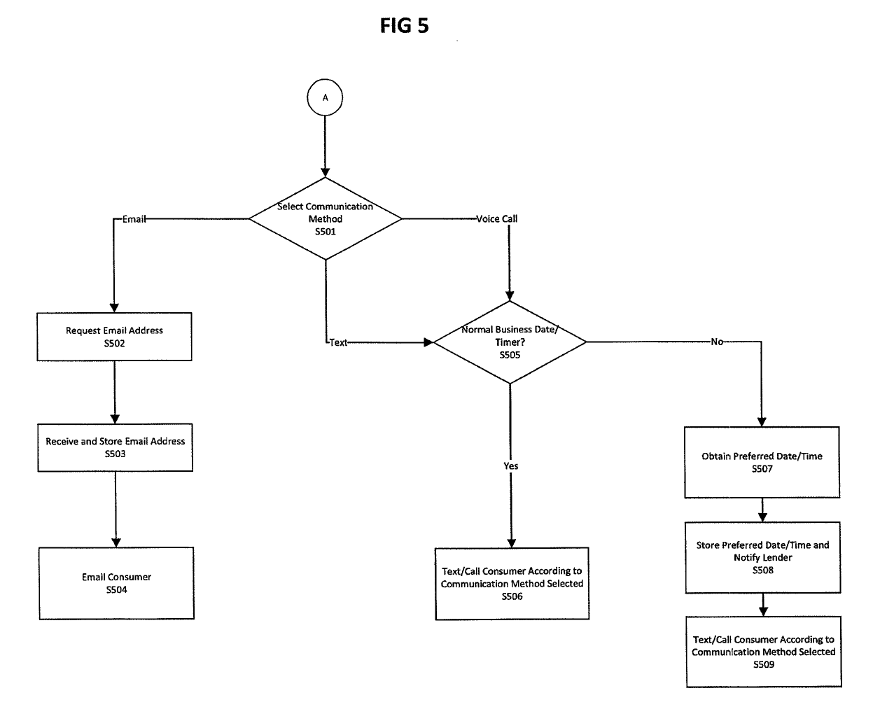

FIG. 5 shows an exemplary flow process for obtaining a preferred communication method, according to an aspect of the present disclosure.

In operation S501, the user is prompted to select a preferred communication method to discuss the estimated mortgage payment information provided in either of S317 or S418 in above noted FIGS. 3 and 4, respectively. In an example, the user may be prompted to select from email, text and phone as the preferred communication method.

If the user selects email as the preferred communication method in S501, the web server sends a request for an email address via a text message in S502.

Once the user provides the email address via a text message, the web server, in operation S503, receives the email address and stores the email address in relation to the phone number of the mobile terminal. Further, the user's preferred communication method may also be saved for a predetermined duration (e.g., 4 hour period, 1 day, or the like). However, aspects of the present disclosure are not limited thereto, such that a preferred communication method may be inquired each time the mortgage payment information is provided.

In operation S504, an email may be generated and transmitted to the mobile terminal. The email may, for example, include contact information of a loan officer/consultant, property address, reference number, operation schedule, parameters provided for the mortgage payment information, details of the mortgage payment information, and the like.

If the user selects either of a voice call or text messaging as the preferred communication method in S501, the method proceeds to operation S505.

In operation S505, a determination of whether the communication is being requested during normal operating schedule for a mortgage company providing the estimated payment information. If the communication is requested during afternoon hours of a weekday that is not a holiday, the mobile terminal receives either of the text communication or voice call in accordance with the selected communication method in operation S506. If the communication is requested during non-operating hours/day (e.g., 5 PM on Sunday), on which most lending institutions are closed, the method may be directed to operation S507. In operation S507, the user may be notified of a normal operating schedule for a respective mortgage company, and requests the user to specify, via a text message, a preferred date and time to receive the text or voice call. Once the user provides the requested schedule information, the requested schedule information may be saved to the web server and the mortgage company may be notified of the call schedule in operation S508.

In operation S509, the mobile terminal receives a text or voice call initiated by the loan company in accordance with the selected communication method.

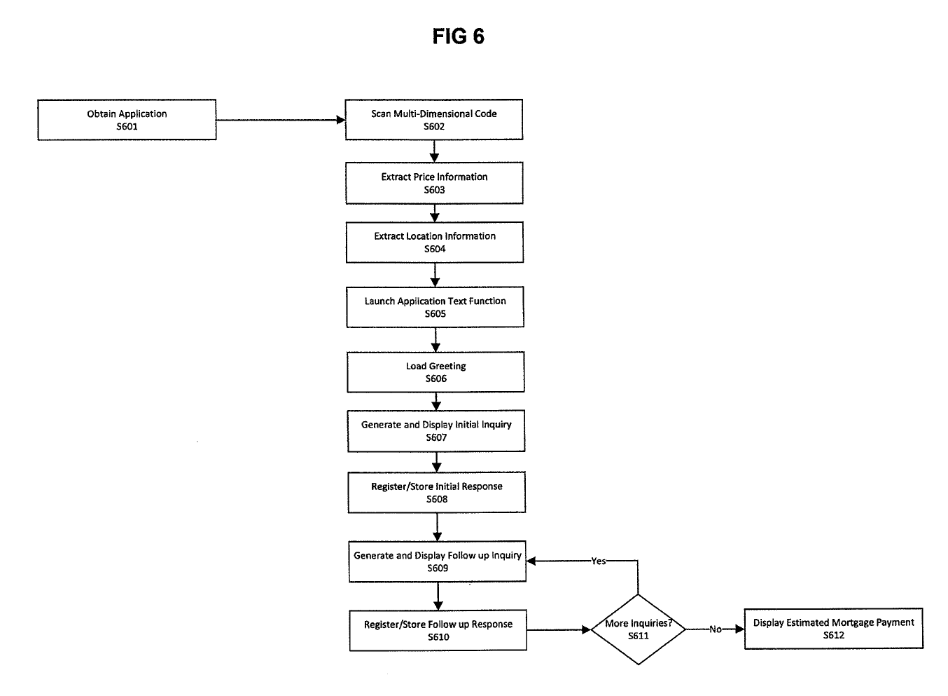

FIG. 6 shows an exemplary flow process for obtaining mortgage information off-line, according to an aspect of the present disclosure.

In operation S601, the mobile terminal obtains a mobile application for providing of mortgage information based on scanning of multi-dimensional barcodes. The mobile terminal may include a display, a processor, a memory, a data receiver, a data transmitter and the like. The mobile terminal may be a smart phone, a personal computing device, a wearable computing device or the like.

In an example, the mobile terminal may obtain such an application from an app store via Wi-Fi connection or a wireless network connection. However, aspects of the disclosure are not limited thereto, such that the application may be obtained through an external memory and other delivery mechanisms. In an example, the mobile application being obtained may include an updated mortgage rate, which may be updated upon presence of a network connection.

In operation S602, an image of a multi-dimensional barcode provided for a target real estate property (or real estate property of interest) is captured or scanned with a camera on a mobile terminal. In an example, the multi-dimensional barcode may be a QR Code®, QYOO® code, or the like. The multi-dimensional barcode may be printed in a black-and-white pattern, grayscale, or any combination of colors. The multi-dimensional barcode may be provided on a “for-sale” sign at a real estate property or on a publication (e.g., printed or digital) of the real estate property. The multi-dimensional barcode may store a custom data path corresponding to information of the real estate property. More specifically, the multi-dimensional barcode may store real estate property data to allow for off-line processing by the application obtained in S601. For example, property address, zip code, and price may be minimally provided for off-line processing. Accordingly, the multi-dimensional barcode may be scanned to provide loan information even in rural areas with spotty wireless network coverage.

In an example, a format of the custom data path may be provided as follows:

loan://x3d7h?address1=3100%20Main%20St&address2=#35&zip=75226&price=
325265
PROTOCOL: loan://
PATH: < id of property >
PARAMETERS: (* is required, otherwise, optional)

* address1 = the first line of the address
address2 = second line of address
* zip = zipcode of property
* price = total price of property
url = website location for property detail page

locale = region/language combo (assumes “us-en” if omitted)

However, aspects of the disclosure are not limited thereto, such that other parameters and format may be included in the multi-dimensional barcode.

In operation S603, price information is parsed and extracted from the information stored in the multi-dimensional barcode.

In operation S604, location information is parsed and extracted from the information stored in the multi-dimensional barcode. The location information may include one or more of the street address and the zip code. However, aspects of the present disclosure may not be limited thereto, such that the location information may be determined based on a GPS signal if the mobile terminal is provided with a GPS receiver. In an example, GPS signals may be available even if cellular or network coverage may be unavailable.

In operation 605, a text messaging function of the obtained application is launched on the mobile device. In an example, the text messaging function of the obtained application may appear similar to default text messaging function of the mobile terminal. However, the text messaging function may be configured to communicate with the application in free text form, without transmitting a text message to an external entity. Various versions of acceptable responses may be predefined for recognition. Further, acceptable responses may also be displayed for input. Accordingly, no formal coding knowledge or network connection may be necessary for its processing.

In operation S606, a default message may be loaded as an initial message. In an example, the default message may display property information, including one or more of property address, zip code, and price information.

In operation S607, the application generates an initial inquiry regarding any special status relevant to the mortgage application, and displays the generated initial inquiry on a display of the mobile terminal via the applications' text function. For example, the inquiry may ask whether the user is part of military service or is a veteran. However, aspects of the present disclosure is not limited thereto, such that the question may inquire whether the user is part of government work force that may be provided with special status during a mortgage application process (e.g., teacher, government employee, and the like).

In operation S608, the user's response to the initial inquiry is registered and stored in a memory of the mobile terminal. In an example, the saved responses may be time stamped and may have a predetermined validity period (e.g., 3 months). The saved responses may be reused for other codes corresponding to other properties, such that no inquiries may be generated for subsequent scanning of codes for receiving mortgage information.

In operation S609, the application generates a follow up inquiry, and displays the follow up inquiry on the display of the mobile terminal. In an example, the follow up inquiry may be based on the user's response. The follow up inquiry may ask regarding the user's expected down payment, estimated credit rating (e.g., excellent, good, fair, poor or a numerical value), first time ownership, primary residence expected, maximum monthly payment desired, desired loan terms, annual salary, and the like. Further, the follow up inquiry may also inquire about a type of the target real estate property (e.g., condo, townhome, a single home, investment home, commercial property, land and the like).

In operation S610, the user's response to the follow up inquiry is registered and stored in the memory of the mobile terminal. The saved responses may be reused for other codes corresponding to other properties, such that no inquiries may be generated for subsequent scanning of codes for receiving mortgage information.

In operation S611, the application determines whether further follow up inquiries are to be generated based on the responses received. If the application determines that additional follow up inquiries are to be generated, then operation S609 is executed. If the web server determines that no further follow up inquiries are to be generated, then the method proceeds to operation S612.

In operation S612, the application generates and displays a response with estimated mortgage information. For example, the estimated mortgage information may include expected monthly payments. The estimated mortgage information may be provided with or without HOA fees, expected taxes, and insurance payments added in. In addition, the estimated mortgage information may provide the user with available loan qualification information based on responses provided. For example, the estimate mortgage information may provide expected monthly payments based on various credit score ranges, if credit score information was not provided by the user. Alternatively, if the user provided the maximum monthly payment information, the web server may provide potential loan products that may be available based on provided responses (e.g., veteran loan, 30 year fixed, specifying minimum down payment required, minimum FICO score required, minimum monthly income, and the like).

As exemplarily described above, the above noted process allows the mobile terminal to more quickly obtain mortgage information without navigating through a website to obtain a mortgage estimate. More specifically, the above noted process may allow providing of mortgage information in areas without cellular or data coverage. Further, the above noted process allows for more efficient delivery of mortgage information by transmitting minimal data for providing of mortgage information. Accordingly, in this regard, the mobile terminal may be relied upon to quickly obtain affordability information even when physically traveling to property sites with slower or less reliable data connections.

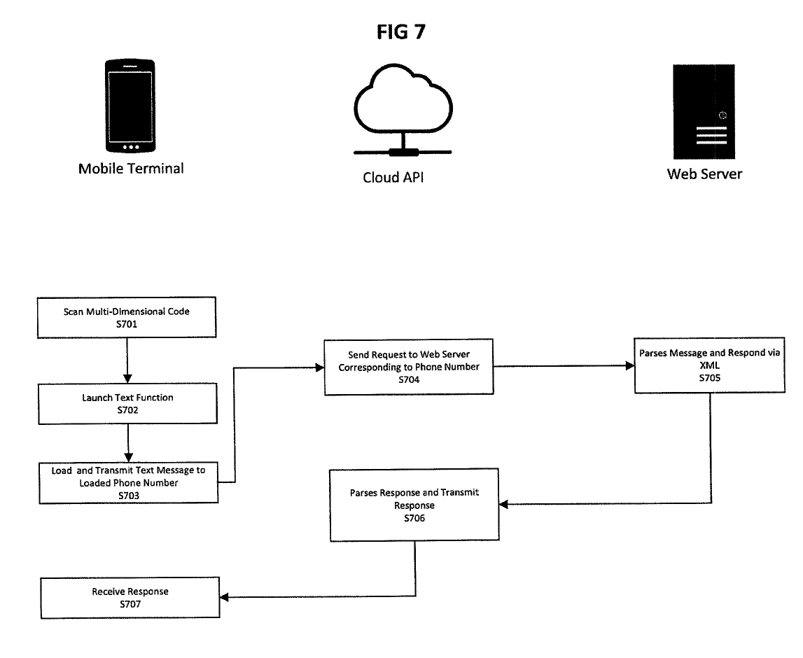

FIG. 7 shows an exemplary data flow for obtaining mortgage information, according to an aspect of the present disclosure.

In operation 701, an image of a multi-dimensional barcode provided for a target real estate property (or real estate property of interest) is captured or scanned with a camera on a mobile terminal. In an example, the multi-dimensional barcode may be a QR Code®, QYOO® code, or the like. The multi-dimensional barcode may be printed in a black-and-white pattern, grayscale, or any combination of colors. The multi-dimensional barcode may be provided on a “for-sale” sign at a real estate property or on a publication (e.g., printed or digital) of the real estate property. The multi-dimensional barcode may store a custom URL corresponding to the target real estate property and/or information of the real estate property. For example, the custom URL may include an identifier or a key corresponding to the target real estate property and a virtual phone number corresponding to a web server including information of the real estate property. However, aspects of the present disclosure are not limited thereto, such that the custom URL may also directly include information of the real estate property.

In operation 702, in response to scanning of the multi-dimensional barcode, a custom URL may be extracted or read from the multi-dimensional barcode and a text function is launched. In an example, the custom URL may be a SMS URL.

In operation 703, a default message corresponding to the custom URL is loaded or generated in a draft text message format and transmitted to a phone number specified in the default message. In an example, the phone number may be a virtual phone number provided by a cloud based API.

In operation 704, the cloud API receives the text message from the mobile terminal for processing. The cloud API may process the text message and transmit a request to a network address of the web server corresponding to the virtual phone number. The request may include the identifier or key corresponding to the target real estate property.

In operation 705, the web server receives the request transmitted through the cloud API, parses the request transmitted, and extracts the identifier or key corresponding to the target real estate property. The web server may further save the phone number of the mobile terminal in its database or memory and retrieves information corresponding to the target real estate property based on the extracted identifier or key. In addition, the web server may generate an initial inquiry for the real estate property. For example, the initial inquiry may ask whether the user is part of military service or is a veteran. However, aspects of the present disclosure is not limited thereto, such that the question may ask whether the user is part of government work force that may be provided with special status during a mortgage application process (e.g., teacher, government employee, and the like). In an example, the initial inquiry may be generated in eXtensible Markup Language (XML) or other similar computer language. Once the initial inquiry is generated, the web server transmits the XML based inquiry to the cloud API.

In operation S706, the cloud API parses and processes the received request, and relays the request in a SMS text format to the mobile terminal.

In operation S707, the mobile terminal receives the initial inquiry in the SMS text format. Communications between the mobile terminal and the web server may be similarly conducted in the manner described above.

Although above noted exemplary embodiments have been disclosed with respect to the multi-dimensional barcodes, such as QR codes, aspects of the present disclosure are not limited thereto, such that other codes capable of including such information being described as being included in the QR codes may be utilized.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

As described above, according to an aspect of the present disclosure, a method is provided for obtaining mortgage information via text message. The method includes scanning, via a camera of a mobile terminal, an image of a multi-dimensional barcode corresponding to a target real estate property; extracting a Short Message Service (SMS) Uniform Resource Locator (URL), via a processor of the mobile terminal, from the multi-dimensional barcode; loading a text message function of the mobile terminal in response to the SMS URL; generating a text message for transmission to a phone number indicated in the SMS URL; transmitting, via a cellular network from the mobile terminal, the text message; loading, at a web server, a custom code for property information of the target real estate property based on the transmission by the mobile terminal; retrieving select information from the property information; transmitting, via a data network from the web server, a first inquiry based on the select information; transmitting, from the mobile terminal, a first response in response to the first inquiry; and transmitting, from the web server, estimated mortgage payment information.

According to another aspect of the present disclosure, the method further includes requesting, to the mobile terminal by the web server, a preferred communication method for receiving communication for the estimated mortgage payment information.

According to yet another aspect of the present disclosure, the preferred communication includes an email, a text message, and a phone call.

According to still another aspect of the present disclosure, the method further includes determining, whether a response to the request for preferred communication method is received within a predetermined time range.

According to another aspect of the present disclosure, the method further includes when the response to the request for preferred communication method is received outside of the predetermined time range: requesting, to the mobile terminal by the web server, a preferred timeframe for receiving communication for the estimated mortgage payment information, and initiating communication at the preferred timeframe in accordance with the preferred communication method indicated by the mobile terminal.

According to yet another aspect of the present disclosure, the method further includes when the response to the request for preferred communication method is received within the predetermined time range: initiating communication at the preferred timeframe in accordance with the preferred communication method indicated by the mobile terminal.

According to still another aspect of the present disclosure, the multi-dimensional barcode is a QR code.

According to another aspect of the present disclosure, the text message is transmitted to the web server through a cloud based Application Programming Interface (API).

According to yet another aspect of the present disclosure, the web server transmits the first inquiry in an eXtensible Markup Language (XML) form.

According to still another aspect of the present disclosure, the mobile terminal transmits the first response in an SMS form.

According to another aspect of the present disclosure, the select information retrieved from the property information includes price information.

According to yet another aspect of the present disclosure, the select information retrieved from the property information includes a zip code of the target real estate property.

According to still another aspect of the present disclosure, the select information retrieved from the property information includes a street address of the target real estate property.

According to another aspect of the present disclosure, the transmitting of the text message includes transmitting the text message to a virtual phone number specified in the SMS URL and residing in a cloud network, and a cloud API of the cloud network receiving the text message transmits a data request to the web server, the data request including information included in the text message.

According to yet another aspect of the present disclosure, the method further includes extracting, from the data request, a phone number of the mobile terminal; and storing, in a memory of the webserver, the phone number of the mobile terminal and the first response.

According to still another aspect of the present disclosure, the first response is time stamped and is assigned a validity period.

According to an aspect of the present disclosure, the stored first response is reused when another image of a multi-dimensional barcode corresponding to another real estate property is scanned via the camera of the mobile terminal.

According to an aspect of the present disclosure, the custom code includes a key linked to information corresponding to a realtor representing the target real estate property and the property information.

According to an aspect of the present disclosure, the method further includes prior to the transmission of the estimated mortgage payment information: transmitting, from the web server to the mobile terminal, a second inquiry based on the first response; and transmitting, from the mobile terminal to the web server, a second response.

According to an aspect of the present disclosure, a computer system includes a mobile terminal, a cloud network, and a web server. The mobile terminal includes a camera configured to scan an image of a multi-dimensional barcode corresponding to a target real estate property; a processor configured to extract a Short Message Service (SMS) Uniform Resource Locator (URL) from the multi-dimensional barcode, and load a text message function of the mobile terminal in response to the SMS URL; and a transmitter configured to transmit, to a phone number specified in the SMS URL via a cellular network, the text message. The cloud network includes a cloud based Application Programming Interface (API) configured to: receive the text message transmitted by the transmitter of the mobile terminal, and in response, transmit a data request to a web server corresponding to the phone number specified in the SMS URL. The web server includes a receiver configured to receive the data request, a processor configured to load a custom code for property information of the target real estate property based on the data request, and to retrieve, from a database, select information from the property information, and a transmitter configured to transmit, via a data network, a first inquiry based on the select information. The transmitter of the mobile terminal is further configured to transmit, to the web server, a first response in response to the first inquiry via the cloud network. The transmitter of the web server is further configured to transmit, to the mobile terminal, estimated mortgage payment information via the cloud network

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for obtaining mortgage information via text message, the method comprising:
scanning, via a camera of a mobile terminal, an image of a multi-dimensional barcode corresponding to a target real estate property;
extracting a Short Message Service (SMS) Uniform Resource Locator (URL), via a processor of the mobile terminal, from the multi-dimensional barcode;
loading a text message function of the mobile terminal in response to the SMS URL;
generating a text message for transmission to a phone number indicated in the SMS URL;
transmitting, via a cellular network from the mobile terminal, the text message;
loading, at a web server, a custom code for property information of the target real estate property based on the transmission by the mobile terminal;
retrieving select information from the property information;
transmitting, via a data network from the web server, a first inquiry based on the select information;
transmitting, from the mobile terminal, a first response in response to the first inquiry; and
transmitting, from the web server, estimated mortgage payment information.

2. The method of claim 1, further comprising:
requesting, to the mobile terminal by the web server, a preferred communication method for receiving communication for the estimated mortgage payment information.

3. The method of claim 2, wherein the preferred communication includes an email, a text message, and a phone call.

4. The method of claim 2, further comprising:
determining, whether a response to the request for preferred communication method is received within a predetermined time range.

5. The method of claim 4, further comprising:
when the response to the request for preferred communication method is received outside of the predetermined time range:
requesting, to the mobile terminal by the web server, a preferred timeframe for receiving communication for the estimated mortgage payment information, and
initiating communication at the preferred timeframe in accordance with the preferred communication method indicated by the mobile terminal.

6. The method of claim 4, further comprising:
when the response to the request for preferred communication method is received within the predetermined time range:
initiating communication at the preferred timeframe in accordance with the preferred communication method indicated by the mobile terminal.

7. The method of claim 1, wherein the multi-dimensional barcode is a QR code.

8. The method of claim 1, wherein the text message is transmitted to the web server through a cloud based Application Programming Interface (API).

9. The method of claim 1, wherein the web server transmits the first inquiry in an eXtensible Markup Language (XML) form.

10. The method of claim 1, wherein the mobile terminal transmits the first response in an SMS form.

11. The method of claim 1, wherein the select information retrieved from the property information includes price information.

12. The method of claim 1, wherein the select information retrieved from the property information includes a zip code of the target real estate property.

13. The method of claim 1, wherein the select information retrieved from the property information includes a street address of the target real estate property.

14. The method of claim 1, wherein the transmitting of the text message includes transmitting the text message to a virtual phone number specified in the SMS URL and residing in a cloud network, and a cloud API of the cloud network receiving the text message transmits a data request to the web server, the data request including information included in the text message.

15. The method of claim 14, further comprising:
extracting, from the data request, a phone number of the mobile terminal; and
storing, in a memory of the webserver, the phone number of the mobile terminal and the first response.

16. The method of claim 15, wherein the first response is time stamped and is assigned a validity period.

17. The method of claim 15, wherein the stored first response is reused when another image of a multi-dimensional barcode corresponding to another real estate property is scanned via the camera of the mobile terminal.

18. The method of claim 1, wherein the custom code includes a key linked to information corresponding to a realtor representing the target real estate property and the property information.

19. The method of claim 1, further comprising:
prior to the transmission of the estimated mortgage payment information:
transmitting, from the web server to the mobile terminal, a second inquiry based on the first response; and
transmitting, from the mobile terminal to the web server, a second response.

20. A computer system, comprising:
a mobile terminal including:
a camera configured to scan an image of a multi-dimensional barcode corresponding to a target real estate property;
a processor configured to
extract a Short Message Service (SMS) Uniform Resource Locator (URL) from the multi-dimensional barcode, and
load a text message function of the mobile terminal in response to the SMS URL; and
a transmitter configured to transmit, to a phone number specified in the SMS URL via a cellular network, the text message;
a cloud network including a cloud based Application Programming Interface (API) configured to:
receive the text message transmitted by the transmitter of the mobile terminal, and
in response, transmit a data request to a web server corresponding to the phone number specified in the SMS URL; and
a web server including:
a receiver configured to receive the data request,
a processor configured to load a custom code for property information of the target real estate property based on the data request, and to retrieve, from a database, select information from the property information, and
a transmitter configured to transmit, via a data network, a first inquiry based on the select information,
wherein
the transmitter of the mobile terminal is further configured to transmit, to the web server, a first response in response to the first inquiry via the cloud network, and
the transmitter of the web server is further configured to transmit, to the mobile terminal, estimated mortgage payment information via the cloud network.
